(19) United States
(12) Patent Application Publication
(10) Pub. No.: US 2005/0074100 A1
(43) Pub. Date: Apr. 7, 2005

(54) Method and apparatus for media distribution system

(76) Inventor: Matthew A. Lederman, New York, NY (US)

Correspondence Address: Matthew Lederman, Apt.6D, 250 W. 103rd St., New York, NY, 10025, US

(21) Appl. No.: 10/431,843

(22) Filed: May 7, 2003

Related U.S. Application Data
(60) Provisional application No. 60/378,688, filed on May 8, 2002.

(51) Int. Cl. H04M 11/00

(52) U.S. Cl. 379/102.01

(57) ABSTRACT

A method and apparatus for selecting and delivering audio, video and interactive media content over a telecommunications network using a media distribution service that enables a remote user to use telephone keypad or voice commands to interact with a media content database to select, access and manipulate stored media content. The media distribution service also provides the ability for one or more remote users to control interactive media content via telephone commands at the same time. The media distribution service is also used to track accounting information using a database for both users and content providers.

### BACKGROUND OF THE INVENTION

This invention was originally filed as Provisional Patent Application No. 60/378,688 on May 8, 2002, entitled “Method and apparatus for media distribution system” by Matthew Lederman.

1. Field of the Invention

The invention relates to telecommunication systems, and to the dissemination of media content via telecommunication systems.

2. Description of Related Art

Jukeboxes and video arcade games are customarily used to deliver media content in restaurants and bars and other commercial establishments. They are traditionally coin operated (modern versions accept bills) and are usually controlled using a front panel interface. They provide the venue in which they are situated with a revenue stream, generally in the form of rent and commission from the operator. They provide the operator of the vending machine with revenue from the cash deposited. They provide the content publisher with licensing revenue.

The music offered to the public from a jukebox is generally limited to the recordings physically loaded into the unit and a technician on a service call is generally needed to change them. This becomes a problem when the tastes of the listening public change. The jukebox operator must first obtain the recordings and then must install them in a timely manner, that is, before the change of taste of the listening public changes again, rendering the choice of music both obsolete and unprofitable. Furthermore, the operator must also change the display panels to reflect the new choices, which is another time consuming and expensive process.

A subtler problem is that the operator may not choose the music that the people in the venue prefer to hear. This would lead to less revenue as consumers may not settle for an alternative, but instead not select music at all or even decide to patronize establishments that have jukeboxes that to their musical taste. And in the absence of customer feedback to the venue, either the venue or the jukebox operator would not know the reason for this lost revenue or even that revenue was lost at all.

Video arcade games have similar problems. A finite number of games (often one) are available on each console and it is possible that the game available is not the game preferred by the patrons. Much like with music, consumer taste changes in video games.

Another problem with video games is that the number of simultaneous players is limited by the number of front panel controls and the size and number of the video displays. So while a two player game can generate twice the revenue as a one-player game, the total number of simultaneous players will be limited by the physical size of the unit.

Another problem with both convention jukeboxes and video arcade games is that the cash box requires emptying on a regular basis. This makes theft of the receipts relatively easy, as cash is difficult to trace. There are systems used in vending machines, especially jukeboxes, that track usage, especially to track royalties. However, it would be very difficult to determine if the operator of the jukebox, rather than an agent or employee of the operator, is cheating the venue, the content providers, and the taxing authorities, or all three, out of at least part of their share of the revenues.

The use of digital technology to distribute media content is common. File sharing on the Internet, as well as the related copyright issues, has been front-page news since the release of Napster. U.S. Pat. No. 6,330,490 describes a vending machine that allows consumers to make custom audio recording by accessing files on a network and manufacturing a recording on demand. U.S. Pat. No. 5,781,889 describes a computerized jukebox capable of playing local digital audio and video content. U.S. Pat. No. 5,848,398 describes system capable of managing a network of jukeboxes, eliminating the need for service calls to update the content inside and count play for royalty payments. U.S. Pat. No. 5,481,509 describes a primitive audio video jukebox. U.S. Pat. No. 5,775,995 describes a system for downloading video games to local terminals for play.

Telephone systems have been extensively used for control applications. Telephones are used to reboot remote computers, for collecting data, and retrieving information. Telephones have even been used in game control applications and to mimic computer “mice” in certain applications.

U.S. Pat. No. 5,236,199 describes a system in which touch tone telephone keypads are used to control remote computers. U.S. Pat. No. 5,218,631 describes a system in which telephone voice and tone responses in conjunction with identification of the telephone number called are used to interact with a game.

The invention described herein uses the telephone to control user selection, download, and delivery of media content as well to provide a return path to the user to interact with the delivered media using a telecommunications network. It also uses the telecommunication network to track accounting information for both users and providers, essentially functioning as a multi-user electronic “coin slot.”

### SUMMARY OF THE INVENTION

An object of this invention is to provide novel telecommunication systems, for use with both residences and public places, primarily adapted to deliver media content, such as music, videos, and interactive games, to individuals and groups of individuals. A related object of this invention is to provide media content providers with a novel effective medium for delivering their media content to individuals as a paid service or for promotional purposes. A further object of this invention is to give media content providers a way to expand the audience for their media content both by delivering an expanded audience for their offerings and delivering a novel medium that allows more people to interact with their content simultaneously.

The present invention provides users with a new method for selecting media content such as music, video, or interactive content, including entertainment, educational, and commercial applications. The present invention also provides media content providers with a new method to deliver, account for delivery, and charge for delivery for this media content. The present invention also provides users with a new method to access interactive media content. The present invention further provides interactive content developers and publishers with a new method for deploying massively parallel, simultaneous multi-user interactive content. Media content control apparatus is provided through which a user can choose a particular item of media content by calling a number and selecting from menus for delivery using media content distribution apparatus. Media control apparatus is provided through which a user can affect a media experience by use of remote input means.

The user may be charged for utilizing the media distribution service or the service may be supported by advertising or other promotional means. The venue or location where the content is delivered, the telecommunication service provider who effects the delivery, the media content provider who publishes the content, the original producer of the content, or other parties may share revenues based on actual usage reflected in the media usage database of the media delivery system.

It is contemplated that a company will establish a telecommunications network in order to deliver the media content to users in residences and public places. This network may take various forms. For example, the company may operate using a pay per call system, such as a “900” toll call. Suitable arrangements may be made between the telephone company and the new company that when a caller dials the number, the telephone company bills the caller directly and takes a portion of the proceeds for that service.

As an alternative, the company may make arrangements for a toll-free “800” number or series of “800” numbers to be used in very nearly the same manner. The caller would dial the “800” number, reaching the media delivery apparatus, and then provide the service with a credit or debit card number, an account number with option personal identification number, or even a promotional code, where the content would be paid for by sponsors or advertisers.

As another alternative a telecommunications carrier may make this an integral part of their offerings by assigning a special number, for example, a mobile carrier could use “#999,” to connect a call on their network directly into the service.

Alternatively, the company may deliver the system over an existing telecommunication network in which the user would be responsible for the costs of transmission in addition to the cost if any of the media content delivered.

Another alternative is that the system itself would dial out to the users at a time and a location that the media will be available for delivery. This alternative could be used, for example, by broadcasters delivering media content on a schedule or by interactive game providers on an earlier request of the user or when it is the users “turn” in a particular game or by invitation of another user.

In concept, the invention is amenable to use in a residence, within a localized area such as a restaurant, bar, or waiting room by one or more individuals. However, it is also amenable for use with a broadcaster in which case the media content would be delivered to the home or business, by over the air, cable, or satellite transmission and is also capable of being used in a theater, area or even stadium setting by a virtually unlimited number of users using one or more multiple display devices.

### BRIEF DESCRIPTION OF THE FIGURES

FIG. 1 is a block diagram of the invention as applied to a telecommunication network having limited capability.

FIG. 2 is a block diagram of the media distribution apparatus.

FIGS. 3, 4, and 5 are block diagrams of modifications of the embodiment in FIG. 1, as applied to telecommunications systems having varied capabilities.

FIGS. 6A, 6B, 6C, 6D, 6E, 6F, 6G, 6H, 61 and 6J, together, are a flow chart representing the operation of the media controller apparatus shown in part in FIG. 1.

FIGS. 7A, 7B, 7C and 7D, together, are a flow chart representing the operation of the media deliverer apparatus shown in part in FIG. 1.

### DETAILED DESCRIPTION OF THE ILLUSTRATIVE EMBODIMENT

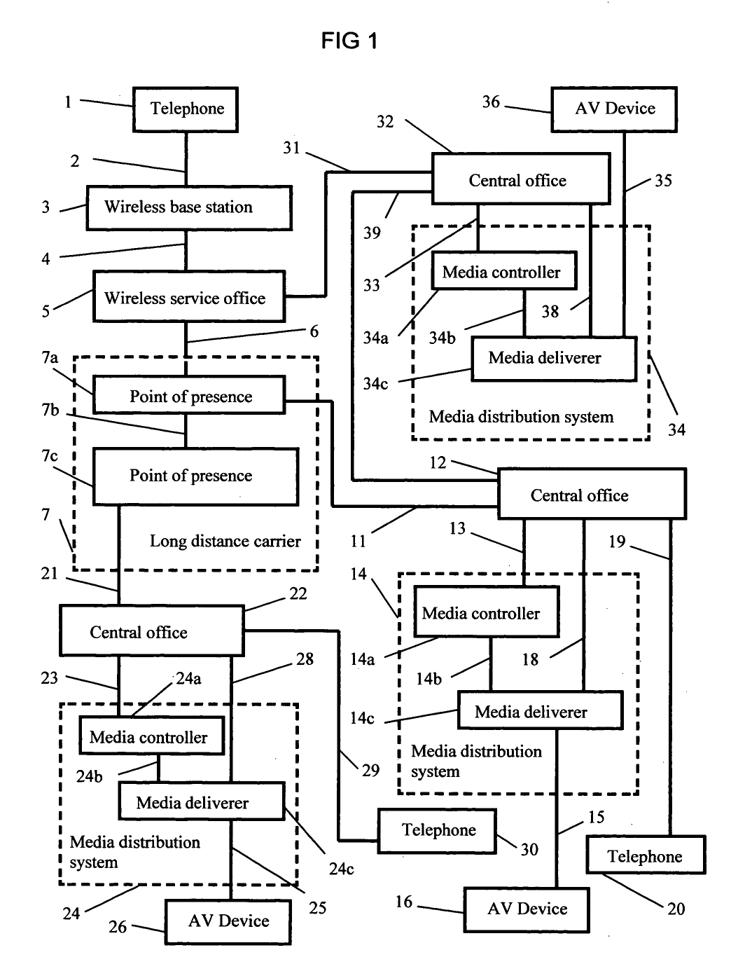

FIG. 1 represents an elemental part of a typical telecommunication network, adapted to serve many purposes of the present invention. In FIG. 1, the calling party's wireless telephone equipment 1 (or “telephone,” briefly) is connected over 2 to the nearest base station 3 of the caller's wireless telecommunication service company. Base station 3 can be located at any of multiple cellular (“cell sites”) or personal communications services (PCS) base stations in a geographic area and may even change over the course of one connection. However, it is shown as one connection here for clarity. Correspondingly, the telecommunications equipment of media distribution service 14 is connected via lines 13 and 18 to the central office 12 of the media distribution service's local telecommunication provider. These lines can be analog, digital or wireless telephone circuits or they may be data circuits. The telecommunications provider can be any entity that provides voice or data connectivity, including the local wire line carrier, an Internet service provider (ISP), or even a cable or satellite television operator. Lines 13 and 18 can be one line, but are shown separately here for clarity. The calling party using telephone 1 is physically located in the same geographic area as media distribution service 14 and is receiving video or audio information or both from attached (via 15) output audiovisual (AV) device 16, such as a monitor or a speaker or a television set. In FIG. 1, service office 5 of the wireless telecommunication carrier is located geographically in the area of the wireless base station 3. Although in the illustrative embodiment of the invention, the caller using equipment 1 is physically beside media distribution service 14 equipment and receiving information from AV device 16, there are other embodiments, which will be described, in which the caller may be widely remote from the media distribution service. The wireless, long distance and local telecommunications service providers may be different companies or organizations or they may all be units of the same company or organization. Furthermore, they may differ in different legal jurisdictions. This may affect the implementation of the invention, but does not materially change the way it functions.

As illustrated in FIG. 1, wireless base station 3 is connected to service office 5 of the wireless carrier by line 4. Line 6 is a direct connection between service office 5 and the local point of presence 7a of the long distance carrier operating the network 7. Line 7b is a direct connection between the geographically distinct point of presence 7a and point of presence 7c of the long distance network 7. A central office is part of a local exchange where telecommunications traffic is connected to other central offices of the local exchange in the same network and points of presence or interconnects of other networks. There may be several central offices in a particular geographic area. A point of presence refers to the facility by which a carrier (generally an interexchange or long distance carrier) connects to another carrier in a particular geographic area and it may be physically inside or adjacent to the central office. Different networks maintain points of presence in the same geographic area and each network maintains a point of presence (or has a relationship with another carrier who does) in each geographic area in which they connect. Only the points of presence, central offices, connections between them needed to demonstrate the invention are shown, but the invention could conceivably connect to all like offices in any area.

Apparatus 14 of a “media distribution service” is connected by lines 13 and 18 to the equipment of central office 12 of the local exchange. Media distribution service 14 apparatus consists of media controller 14a apparatus and media deliverer 14c apparatus. The connection from the media controller to the media deliverer is diagrammatically represented by line 14b, which can be any telecommunication connection, for example, dial up or Ethernet. Elements 14a and 14c are either separate apparatuses or they are combined in one piece of apparatus. They are shown separated here to call attention to their separate functions and to represent the feasibility of providing separated pieces of equipment for performing their separate functions, as will be demonstrated.

Wireless base station 3 can handle multiple wireless connections simultaneously. Lines 4, 6, 7b, 11, 13, and 18 each carry one call at a time or they each carry many calls simultaneously using multiplexing techniques.

In using the apparatus of FIG. 1, the calling party sees a telephone number displayed on audiovisual device 16 connected to media distribution service apparatus 14. Although this could be any number, including international, long distance, local, or even a “*” or “#” code, for the purposes of this first example, the displayed number is served by long distance carrier 10 even though the wireless equipment 1 is physically proximate to media distribution service 14. Moreover, several different numbers can resolve to the same ultimate party. For example, “800,” “900,” and local numbers are often routed to the same telephone service, the only difference in their treatment by the responsible telephone companies being in how they are billed. The calling party enters the displayed number into wireless telephone 1 in order to connect to the media distribution service. The caller's wireless equipment transmits this number to wireless base station 3 of the caller's wireless carrier (or even a wireless carrier they are local to that has a service agreement with the caller's wireless carrier), which establishes a connection with wireless equipment 1. The wireless base station 3 then connects to the local wireless service office 5 of the wireless telecommunications carrier via line 4. Equipment at the wireless service office 5 checks the number in a routing database, determines that it is served by long distance carrier 10 and connects over line 6 to point of presence 7a of long distance network 7. Equipment at point of presence 7a checks the number against its routing database and connects over line 11 to central office 12 of the local exchange. Equipment at central office 12 connects to media controller service 14a of media distribution service apparatus 14 via line 13.

Media distribution service media controller 14a apparatus responds to an incoming or received call by taking the telephone number of the calling party and the telephone number of the called party off the line using automatic number identification (ANI) and dialed number information service (DNIS) technology and placing them in temporary computer storage. The calling telephone number and the called telephone number are provided in any of several different ways, as by transmitting tones on the line, by sending a stream of bits or by using a separate signaling circuit. Media controller 14a checks the telephone number of the called party against a database. If the telephone number corresponds to a valid pay-per-call number for the media distribution service, media controller 14a outputs an appropriate audio message to the caller and outputs a similar video (and optionally audio) message for the system display. If the pay-per-call number combined with information from the database corresponds to a video selection number, the message would be something similar to “Welcome to . . . . Each movie selection costs 3 dollars and each music video selection costs 50 cents. Each selection will be charged to your telephone bill, press or say ‘1’ to continue . . . ” If, for example, the pay-per-call number combined with information in the database corresponds to a music selection number, the message would be something similar to “Welcome to . . . Each album selection costs 2 dollars and each single-track selection costs 25 cents. They will be charged to your telephone bill, press or say ‘1’ to continue . . . ” If the pay-per-call number combined with information in the database corresponds to a video game selection, the message would be something like “Welcome to . . . Games cost 5 cents per minute per player to play and will be charged to your telephone bill, press or say ‘1’ to continue.” If the called number corresponds to a credit card, debit card, or charge account video or music line, the system would check to see if there was an existing credit card in the database associated with that telephone, and if found, would play and display a message like, “Press or say ‘1’ to use the [credit card/debit card/account number] associated with this telephone . . . ” where the text in brackets varies depending on data retrieved from the various databases. If the caller chose to use the associated card, the system would play and display a message like “Please say or enter your pin number now.” If there were no card associated with the telephone number or the caller chose not to use it, the message would be something like “Welcome to . . . Each . . . selection costs . . . dollars and each . . . selection will costs . . . cents and will be charged to . . . Press or say ‘1’ to continue . . . ” and the next set of prompts, asking for the account information” will only be directed to the telephone for security and will be something like “Press or say your credit card number,” followed by “Press or say your pin number,” or “Press or say the expiration date,” or both followed by other security prompts as desired by the company. After the account numbers have been entered and validated, the system would play and display a message like, “Press or say ‘1’ to associate this account with this telephone number . . . ” If the called number corresponds to a number corresponding to a promotion code, the message could be as simple as “Welcome to . . . Press or say your promotion code now.” And in the case that the system is entirely advertiser supported, the message could merely say “Welcome,” though optional demographic data could be collected at this point, “Please press or say your age,” “Press or say ‘1’ if you are male, press or say ‘2’ if you are female,” etc.

If the caller has selected video, media controller 14a prompts for a specific choice. Media can be categorized by genre, artist, title, most popular, stored local to the media delivery service, or even by pre-assigned identification number, for example. Media controller 14a prompts the caller on the screen and on the line, “Press or say ‘1’ to select, by genre, press or say ‘2’ to select by artist, press or say ‘3’ to select by title, press or say ‘4’ to select by most popular, press or say ‘5’ for all the choices on the ‘jukebox’, or press or say the number of any video you want. Press or say ‘0’ to repeat this menu . . . ” The prompts given by media controller 14a depend on the previous choices made by the caller which it keeps in temporary storage so that new prompts are accessed from the system in the proper context of the call. Subsequent prompts or messages narrow the choices available to the caller. For example, if the caller selects ‘1’, the message will be something like “Press or say ‘1’ for features, press or say ‘2’ for rock, press or say ‘3’ for rap . . . Press or say ‘0’ to repeat this menu, press or say ‘9’ to go back one menu.” If the caller selects ‘1’, the message will be something like “Press or say ‘8800’ for ‘Titanic’, press or say ‘8801’ for “Jurassic Park’ . . . Press or say ‘0’ to repeat this menu, press or say ‘9’ to go back one menu, press or say ‘1’ to repeat the last selection, press or say ‘2’ to repeat the last two selections . . . ” Once the caller has selected a video, the media distribution system will prompt the caller on screen and on the line to make sure that it is the video desired, “You have selected . . . Press or say ‘1’ if this is correct,” and waits for the caller to confirm. Media controller 14a connects to media deliverer 14c via line 14b to check if the selection is already local to the media delivery system. If the caller has selected a video that is already local to the media delivery system, the system will prompt the user with a message as to when the video will start based on the number of selections that are in the queue ahead of it, “Your selection . . . will start playing in . . . ” If the caller selects a video that is not already local to media deliverer 14c, the system locates the video in the network, prompts the caller as to how much time download will require and asks the user to confirm that the selection is still desired, “Your selection will download in . . . Press or say ‘1’ if you still wish to make this selection . . . ” If the user chooses to continue, the system will prompt the user that download will commence and give an estimated time of delivery, “Downloading has started. Your selection . . . will begin playing in . . . ” Finally, the media controller 14a will prompt the caller for another selection, “Press or say ‘1’ to make another selection, press or say anything else to exit.”

Similarly, if the caller has selected music, media controller 14a also prompts them for a specific choice. Selections can be again be categorized by genre, artist, title, most popular, stored local to the service, or even by pre-assigned identification number, for example. Media distribution system prompts the caller on the screen and on the line, “Press or say ‘1’ to select by genre, press or say ‘2’ to select by artist, press or say ‘3’ to select by title, press or say ‘4’ to select by most popular, press or say ‘5’ for all the choices on the ‘jukebox’, or press or say the number of any video you want. Press or say ‘0’ to repeat this menu.” If the caller selects ‘1’, the message will be something like “Press or say ‘1’ for pop, press or say ‘2’ for rock, press or say ‘3’ for rap . . . Press or say ‘0’ to repeat this menu, press or say ‘9’ to go back one menu.” If the caller selects ‘1’, the message will be something like “Press or say ‘8400’ for ‘Thriller’, press or say ‘8401’ for ‘Candle in the Wind’ . . . Press or say ‘0’ to repeat this menu, press or say ‘9’ to go back one menu, press or say ‘1’ to repeat the last selection, press or say ‘2’ to repeat the last two selections . . . ” Media controller 14a may also prompt the caller on the screen and on the line for selection length, “Press or say ‘1’ for singles, press or say ‘2’ for albums” which it stores for use in retrieving selections from the database to present to the caller. Once the caller has selected some music, the media delivery system will prompt the caller on screen and on the line to make sure that it is the desired choice, “You have selected . . . press or say ‘1’ if this is correct,” and waits for the caller to confirm. Media controller 14a connects to media deliverer 14c via line 14b to check if the selection is already local to the system. If the caller has selected content that is already local to the media deliverer, the system will prompt the user with a message as to when the music will start based on the number of selections that are in the queue ahead of it, “Your selection . . . will begin playing in . . . ” If the caller selects something that is not already local to media deliverer 14c, the system locate content on the network, prompts the user as to how much time download will require, and asks the user to confirm that the selection is still desired, “Your selection will download in . . . Press or say ‘1’ if you still wish to make this selection . . . ” If the user chooses to continue, the system will prompt the user that download will commence and give an estimated time of delivery, “Downloading has started. Your selection . . . will begin playing in . . .” Finally, the system will prompt the caller for another selection, “Press or say 1 to make another selection, press or say anything else to exit.”

If the caller has selected interactive content or application, like a game, media controller 14a also prompts them for a specific choice. These can be categorized, for example, by genre, publisher, title, most popular, stored local to the service, or even by pre-assigned identification number. Media controller 14c again prompts the caller on the screen and on the line, “Press or say ‘1’ to select by genre, press or say ‘2’ to select by publisher, press or say ‘3’ to select by title, press or say ‘4’ to select by most popular, press or say ‘5’ for all the choices on the ‘jukebox’, press or say ‘6’ to join an application in progress, or press or say the number of any application you want. Press or say ‘0’ to repeat this menu.” If the caller selects ‘1’, the message will be something like “Press or say ‘1’ for sports, press or say ‘2’ for adventure, press or say ‘3’ for casino . . . Press or say ‘0’ to repeat this menu, press or say ‘9’ to go back one menu.” If the caller selects ‘1’, the message will be something like “Press or say ‘8900’ for ‘Football’, press or say ‘8901’ for ‘Baseball’ . . . Press or say ‘0’ to repeat this menu, press or say ‘9’ to go back one menu, press or say ‘1’ to repeat the last selection, press or say ‘2’ to repeat the last two selections,” Once the caller has selected, media controller 14a will prompt the player on the screen and on the line to make sure that it is the application desired, “You have selected . . . press or say ‘1’ if this is correct,” and waits for the caller to confirm. Media controller 14a connects to media deliverer 14c via line 14b to check if the application is already stored on the local media deliverer 14c. If the caller has selected an application that is already local to media deliverer 14c, media controller 14a will prompt the user with a message as to when the application will start based on the number of selections that are in the queue ahead of it, “Your selection . . . will begin in . . . ” and stores the application related information in the database. If the caller selects an application that is not already local to the system, media controller 14a will prompt the user as to the time required before the application will run and ask if the user still wants to make that selection, “Your selection . . . will require . . . minutes to download. Press or say ‘1’ if you still wish to choose this application . . . ” If the caller elects to select this application, the system will direct media deliverer 14c to acquire the media from another media deliverer, prompt the user that download will commence and give an estimated time of delivery, “Downloading has started. Your selection . . . will commence in . . . ” and will enter the application information into the database. If the application can be played as a multiplayer game, the media controller prompts the caller, “Press or say the number of players you want to play this game” and waits for the caller's response. If the caller enters more than one, the system enters this information in the database and outputs a message prompting for new players, “To play [number of players] [name of game] in [countdown time/actual time] call [pay-per-call number] or [credit card number] or [debit card number] now. Number of players need: [number of players needed],” where the information contained in brackets varies depending on information retrieved from the databases or other system resources. The countdown timer is the time in minutes, seconds or even hours until the application is scheduled to commence and is decremented each second. Actual time is the actual local time that the application scheduled to start. The system decrements number of players needed as players take the slots and enters their information in the database. If the application is scheduled for sometime in the future, the media distribution system will prompt the player. “The system will call you when the game is ready to begin, please be patient.” Finally, the system will prompt the caller for another selection, “Press or say 1 to make another selection, press or say anything else to exit.”

Selections in the queue are output via audiovisual device 16 of media deliverer 14c with their estimated time of delivery. When a new selection is found in the queue for processing, the name, type and start time are entered into the database. If it is a video selection, the video content can be displayed on a monitor of audiovisual device 16 attached the system video output (and any other monitors attached that have been configured to mirror it) and the audio can be played using speakers of audiovisual device 16. The system video or audio outputs or both of media deliverer 14c can also be attached to the head end of a broadcast facility making the system output a television or radio production. If it is an audio selection, media deliverer 14c can play it using speaker attached to the audio output and can use the system video outputs to show advertisements or other content. If the selection is interactive video content, such as a game, media controller 14a scans the telecommunications ports to see if the users are already connected. If they are not, media controller 14a attempts to access the telephone numbers that the callers had used to sign up for the application and waits for them time to answer. If they do not answer in a timely manner, media controller 14a removes the entries for the calls that were not answered, and displays using media deliverer 14c a call for as many new users as needed for a variable length of time, “To play [number of players] [name of game] in [countdown time/actual time] call [pay-per-call number] or [credit card number] or [debit card number] now. Number of players need: [number of players needed],” where, again, the text contained in the brackets depends on information retrieved from the system or its databases.

Once the interactive video content has started and all the players are connected, media controller 14a monitors the connection on line 18 for inputs. These inputs are in the form of voice, tones or data and are in response to onscreen or over the phone line prompts given to the connected players. Media controller 14a accepts the inputs, processes them, and passes them to the game being output using media deliverer 14c. These inputs vary with the interactive entertainment selected and take the form of keypad commands, for example, pressing the “4” key to go left or the “6” key to go right, voice commands, for example, saying “left,” “right,” or “fire” into the telephone, or even mouse, keyboard other game controller technology depending on how the user is accessing the system.

When the selected media delivery ends, media deliverer 14c updates the accounting database and the next item in the queue is selected.

All other media choices are handled similarly by media control 14a apparatus in response to varying user input and database information.

The additional feature in which a user can access a media distribution service in a geographically remote area is also demonstrated in FIG. 1 with a user at telephone 1 accessing media delivery service 24. In this example, the audiovisual outputs 26 connected via 25 to media deliverer 24c are television broadcast equipment transmitting in the area in which telephone 1 is located. A telephone number output from media deliverer 24c is entered by the caller into telephone 1 as in the previous example and is connected through wireless base station 3 and service office 5 to point of presence 7a of long distance carrier 7. In this example, however, equipment at point of presence 7a checks the number in the routing database and connects the call via line 7b to remote point of presence 7c of long distance carrier 7. Equipment at point of presence 7c checks the routing information and connects over line 21 to central office 22. Equipment at central office 22 connects to media controller 25a by line 23. At this point, media distribution service is 24 connected in a manner similar to media distribution service 14 in the first example. If, however, in response to user input, media controller 24a determines that the media requested is not local to media deliverer 24c, but is physically located on media deliverer 14c, media controller 24a instructs media deliverer to acquire the media. To accomplish this, media deliverer 24c connects on line 28 to central office 22. Equipment at central office 22 connects via line 21 to point of presence 7c of long distance network 7. Equipment at point of presence 7c connects over line 7b to point of presence 7a. Equipment at point of presence 7a routes the call on line 11 to central office 12, which connects to media deliverer 14c over line 18. Media deliverer 14c then sends the desired media back over the circuit just described to media deliverer 24c for ultimate delivery to the caller at telephone 1. Once the media has been stored on media deliverer 24c, media deliverer 24c notifies media controller 14c that the requested media is now local. Optionally, media deliverer 24c can notify other media controllers of this change in stored media immediately or at specified intervals.

If the desired media had been stored on media deliverer 34c instead of 14c above, connection would have been routed similarly to central office 12, but once there would have been connected to line 39 to central office 32 and then to media distribution service 34 to acquire the file similarly.

The additional feature in which a user can access a media distribution service without use of the long distance network is also shown in FIG. 1. For example, if the number output from media deliverer 34c of media distribution service 34 over 35 and displayed on audiovisual device 36 is a number local to the wireless service office 5, when the call originating at telephone 1 gets to service office 5, the routing database directs that the call connected over line 31 to central office 32. Equipment at central office 32 routes the call over line 33 to media controller 34a. At this point media distribution service 34 operates similarly to media distribution service 14.

Similarly, the additional feature that a caller using a wire line telephone can interact with broadcast originating from media distribution service in a geographically remote area is demonstrated in FIG. 1. Caller using telephone 30 connects to central office 22 via line 29 and then to point of presence 7c of long distance carrier 7. Equipment at point of presence 7c routes the call over line 7b to point of presence 7a. Equipment at point of presence 7a routes the call over line 11 to central office 12. Central office 12 then connects to media distribution service 14 as in the first example.

The additional feature that a caller using a wire line telephone can access a media distribution service without use of a long distance network is also demonstrated in FIG. 1. This is the case where a caller accesses media using a local telephone number, such as a “976” pay per call exchange or even just a local number. Caller at telephone 20 connects to central office 12 over line 19. Equipment at central office 12 connects over line 39 to central office 32. Central office 32 connects to media distribution service 34. At this point media distribution service 34 operates similarly to media distribution service 14.

The additional feature that media distribution service 14 using media controller 14a initiates the call to telephone 20 via line 13 to central office 12 and line 19 when media deliverer 14c is ready to provide content to AV device 16 via line 15 can be implemented in all embodiments of this system. Once the call has been connected.

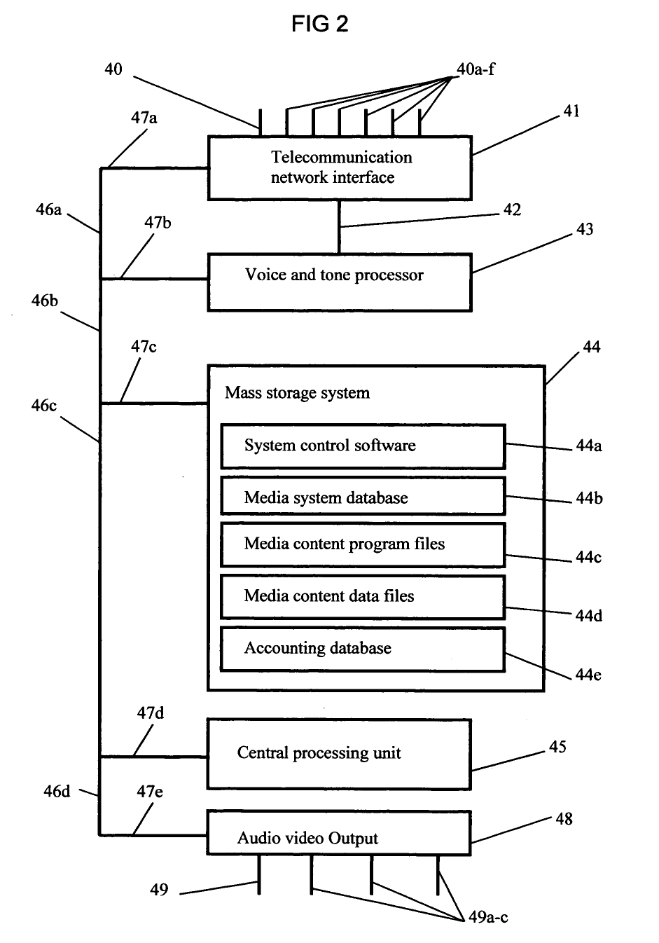

FIG. 2 shows a functional block diagram of media distribution service apparatus 14 of FIG. 1, including the apparatus of both media controller 14a of FIG. 1 and media deliverer 14c of FIG. 1. Media controller 14a apparatus includes telecommunication network interface 41, voice and tone processor 43, mass storage system 44 and central processing unit 45 shown in FIG. 2, as well as software for performing various distinct functions. Media delivery apparatus 14c also includes telecommunications network interface 41, voice and tone processor 43, mass storage system 44, central processing unit 45, and additionally, system audio video output 48. Although, media controller 14a and media deliverer 14c are shown separate in FIG. 1 to emphasize their functional difference, media controller 14a and media deliverer 14c either exist separately or are integrated in one assembly as shown in FIG. 2.

Lines 40 and 40a-40f in FIG. 2 are the various lines that connect the telecommunication network interface 41 of the media distribution service to the telecommunication network. These lines can be dialup, digital subscriber line, cable modem, Ethernet, or any other telecommunication technology, and combinations of any or all of the preceding. Lines 49 and 49a-49c are the various circuits that connect the audio video output 48 to monitors, televisions, speakers, amplifiers, and other audio and video rendering equipment. These can be composite or component video, digital video, or any other audiovisual technology, and combinations of any or all of the preceding. The roles of these lines are explained in the discussion that follows. The overall system is controlled by central processing unit 45 using software and data stored on mass storage system 44. Voice and tone processor 43 is used to convert messages stored in the apparatus into voice signals for delivery to the connected parties. Voice and tone processor 43 also captures received tones, pulses, and voice input and generates tones for media control. Voice and tone processor 43 also monitors the connected circuits lines to determine the status of the calls.

Mass storage system 44 is used to store the digitized files including the storage for media distribution service system control software 44a, media system database 44b, media content program files 44c, media content data files 44d, as well as accounting database 44e of the media distribution service apparatus.

System control software 44a includes the programming that selects user prompts, interprets user inputs, accesses the various databases, and delivers the actual media content. System control software 44a also contains certain data and files, for example, digitized voice prompts, needed to properly operate the system. This software includes billing software and accounting software that access data stored in accounting database 44e. This software can reside and be executed on one or more different computers simultaneously and is shown as one here only for simplicity.

Media distribution system database 44b contains information relating to the telephone numbers associated with the various media deliverers as location of the media content on the various media deliverer apparatus in the network. This database can be several different databases residing on multiple computers, but is shown here as one for simplicity.

Media content program storage 44c contains the interactive video games and other interactive products (including educational, informational and transactional software) that callers access using the system. This storage also includes certain data and files needed to properly run the stored software. This content can reside on more than one computer simultaneously, as multiple copies of the same content.

Media content data storage 44d contains the audio and video content that users access using the jukebox capabilities of the system. This storage also includes data and files used to enhance the basic content. This content can also reside on more than one computer simultaneously, as multiple copies of the same content.

Accounting database 44e contains information relevant to user access as well as content provider so that customers can be billed and vendors can be paid. This database can include account information, such as credit card data, billing addresses, and inventory. This database can be several different databases, but are shown as one grouped by function here for simplicity.

Central processing unit 45 uses the control software to direct and monitor the apparatus. Central processing unit 45 controls media timing and media usage by keeping delivery criteria, media content criteria, accounting information and other data input by the user or retrieved from any of the relevant databases in temporary storage in order to present users with appropriate selection criteria, delivery information, etc.

Line 42 provides an internal “bus” for telecommunications network interface 41 to connect with voice and tone processor 43 to facilitate monitoring, control and passing of information. Computer bus 46a, 46b, 46c and 46d is connected via circuit 47d to central processing unit 45 which enables communication with the rest of the apparatus using circuits 47a, 47b, 47c and 47e which connect the telecommunications network interface 41, voice and tone processor 43 and mass storage system 44 of the media distribution service apparatus to the computer bus.

In FIG. 2, line 40 is the particular connection that carries the call initiated by the caller in this discussion to the telecommunications interface 41. (This line 40 corresponds to line 13 in FIG. 1.) The call is “answered” and then routed from telecommunications network interface 41 on the telephone bus 42 to voice and tone processor 43, which takes information representing the telephone number of the caller and the information representing the telephone number of the number called off the line. The called and calling numbers are routed via circuit 47b, the computer bus 46b and 46c and then circuit 47d to central processing unit 45, where they are placed them in temporary computer storage. Central processing unit 45 then checks the telephone numbers for associated action using data accessed via circuit's 47d, 46c and 47c from the mass storage system 44. These data are also loaded into temporary storage in the central processing unit 45. The called number is checked against a database of numbers stored in media system database 44b associated with media delivery services. This is crucial in the case where the media controller apparatus must choose from many possible media deliverers. The central processing unit 45 checks the calling number against a database of numbers that have been blocked for any reason stored on mass storage system media system database 44e. Note that if any of these databases reside on a remote system, the central processing unit 45 accesses on line 40a, for example, of telecommunication network interface 41 and, either using dial up or dedicated means as detailed above, connects to that the media distribution system. If the number is not blocked, central processing unit 45 directs the voice and tone processor 43 to send a message for the caller such as “Each . . . selection costs . . . per . . . Please press or say ‘1’ to continue, . . . ” using a message stored in the mass storage system control software 44a. Central processing unit 45 also provides video prompts using system audio video output 48 via line 49. If the called number corresponds to a credit or debit card selection, the central processing unit 45 directs voice and tone processor 43 to deliver a message for the caller such as “Each . . . selection costs . . . per . . . Please enter your card number . . . ” using a different message stored in the mass storage system 44a. Central processing unit 45 also provides video prompts using system audio video output 48 via line 49. Numbers associated with advertising supported or promotional services are treated similarly, with the central processing unit 45 directing the voice and tone processor 43 to deliver an appropriate message for the caller. Central processing unit 45 optionally will direct voice and tone processor 43 to prompt the caller for additional information such as expiration date or pin number or both and then accesses accounting database 44e locally or a payment service remotely in order to approve the use of the account which central processing unit 45 accesses on an available line 40c. Central processing unit 45 will then store the data in temporary storage. If the called number was not associated with a particular service, central processing unit 45 directs voice and tone processor 43 to deliver a message for the caller such as “Press or say ‘1’ to play a video, press or say ‘2’ to play a song or press or say ‘3’ to play a game. Central processing unit 45 also provides video prompts using system audio video output 48 via line 49. Central processing unit 45 gets the response from voice and tone processor 43 and stores it in temporary storage and directs voice and tone processor 43 to deliver an appropriate message, such as “Press or say ‘1’ to select by genre, press or say ‘2’ to select by artist . . . ” Central processing unit 45 also provides video prompts using system audio video output 48 via line 49. Central processing unit 45 gets responses from voice and tone processor 43, stores the responses in mass storage 20, and directs voice and tone processor 43 to deliver appropriate messages to the caller until the desired media content is determined. Central processing unit 45 also provides video prompts using system audio video output 48 via line 49. Central processing unit 45 then determines if the desired media content is currently stored on the local media delivery system mass storage 44 by checking media system database 44b. If it is, central processing unit 45 directs voice and tone processor 43 to deliver a message such as “Your selection will begin to play in . . . ” Central processing unit 45 also provides video prompts using system audio video output 48 via line 49. If the desired media content is not currently stored on the mass storage system, central processing unit 45 will direct voice and tone processor 43 to deliver an appropriate message for the caller such as, “Your select will require a . . . minute download. Press or say ‘1’ if you still wish to make this selection.” Central processing unit 45 also provides video prompts using system audio video output 48 via line 49. If the caller chooses to continue, central processing unit will cause an appropriate message to be delivered to the caller and access a remote server on an available line 40b.

If the caller has selected multi-user interactive content, central processing unit 45 directs voice and tone processor 43 to deliver a message requesting the number of players desired, “Press or say the number of players you want . . . ” Central processing unit 45 also provides video prompts using system audio video output 48 via line 49. Central processing unit 45 gets the response and stores it in temporary memory. If it is more than one, central processing unit 45 directs the display to call for more players, “To play . . . call . . . and enter game number . . . ” Central processing unit 45 also provides audio or video prompts or both using system audio video output 48 via lines 49.

Referring again to FIG. 2, prior to or during the time that the caller is connected, one or more media content items is selected for delivery. If the items selected are not interactive, the caller may disconnect after selection is made freeing up the line for new callers. If the media content selected is interactive, then the caller must be connected to use his telecommunications equipment to play. If the caller has selected interactive content but the interactive content requires download or is still in the queue, central processing unit 45 stores the calling number in temporary storage and directs the voice and tone processor to deliver the message, “The system will call you when the game is ready to begin.” Central processing unit 45 also provides audio or video prompts or both using system audio video output 48 via lines 49.

When the game is ready to begin, central processing unit 45 retrieves the telephone numbers from temporary storage and directs the voice and tone processor 43 to connect them using telecommunications network interface 41. Central processing unit 45 also outputs a message on audio video output 48 via line 49. Central processing unit 45 allots them time to answer or call back in, but if the previously registered players do not respond, the system will output a call to the system display for new players, “To play . . . now call . . . and enter game number . . . ” Central processing unit 45 also provides audio or video prompts or both using system audio video output 48 via lines 49.

When each media content delivery terminates, central processing unit 45 is programmed to update the accounting information in the accounting database 44e in the mass storage system 44 relevant to the particular media content by storing the media content identifier, to increment and store in a counter the total number of times the selected media content has been delivered, to store the telephone numbers of the calling parties, and to store the date and time the media file was delivered. This information may be uploaded to a central server by means of the central processing unit 45 directing the voice and tone processor 43 to use an available line-40b of the telecommunication network either using a dial up or dedicated connection. This upload can be scheduled for a time period when the media distribution service is idle or can be accomplished by an operator.

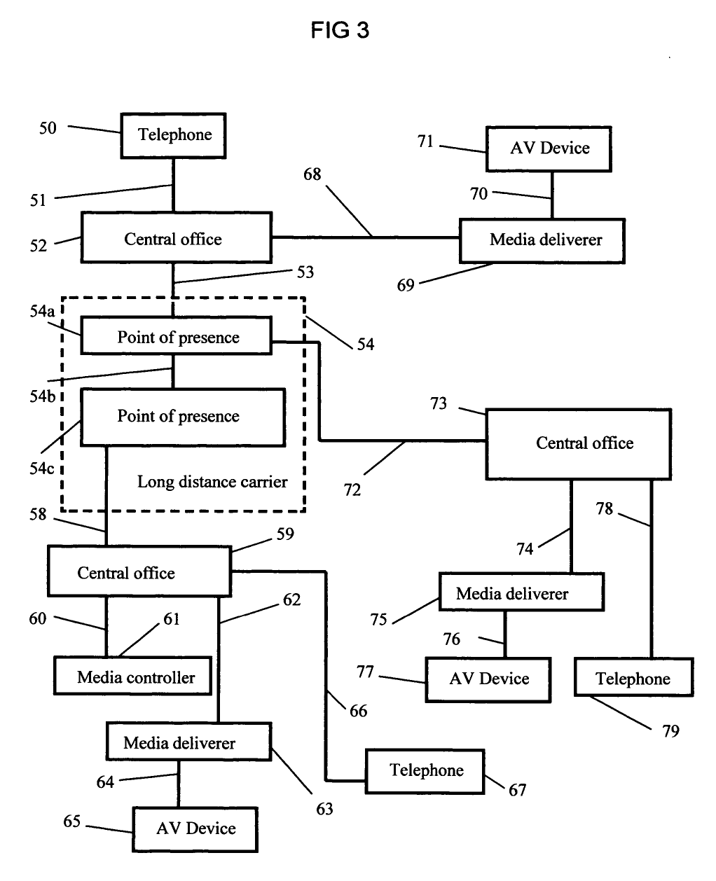

The diagram of FIG. 1 illustrates the system including the media distribution service as it applies to a call reaching the dedicated media distribution service. This will be a common implementation of the invention, for example, in a bar or restaurant where patrons select music and play video games on a dedicated system using their mobile telephones. A more comprehensive representation of a telecommunication system that includes the media distribution service apparatus is shown in FIG. 3. This figure shows the whole system as it applies to a user in any part of the system of FIG. 1 using the system to deliver media content to any residential or commercial establishment including those that do not have dedicated media distribution apparatus or even wire line telecommunications equipment. As shown in FIG. 3, this capability is implemented by adding a central media controller 61 connected over the telecommunication network to several media deliverers 63, 69, and 75. Media controller 61 differs only from the media distribution service 14 apparatus in FIG. 1 in that it is not equipped with media delivery equipment. Media deliverers 63, 69, and 75 likewise differ only from media distribution service 14 apparatus in FIG. 1 only in that they do not contain media control apparatus.

A call originating at telephone 50 is connected via line 51 to central office 52. Equipment at central office 52 checks the called number, which for this example is a toll free “800” number, against a routing database and connects via line 53 to point of presence 54a of long distance network 54. Equipment at point of presence 54a checks the number and connects over line 54b to point of presence 54c. Equipment at point of presence 54c connects over line 58 to central office 59. Equipment at central office 59 connects to media controller 61 over line 60.

Media controller 61 responds to the connection similarly to FIG. 1 with the exception that, as it has no media delivery apparatus, it checks the database to find out if there is a media delivery apparatus local to the origination of the request that has the desired media available locally. Media controller 61 is able to determine which media delivery apparatus caused the user request, in this case media deliverer 69, by checking the called number in the media system database 44b (FIG. 2) and is able to check if the media requested is stored on media deliverer 69 again by checking media system database 44b (FIG. 2). If it is determined that media is currently stored locally on media deliverer 69, media controller 61 establishes a connection via line 60 to central office 69, via line 58 to long distance network 54, via line 53 to central office 52, and via line 68 with media deliver 69 and instructs it to deliver the desired media on audiovisual device 71 over line 70. Media deliverer 69 then checks that the media is local using media system database 44b (FIG. 2) and then the actual media storage 44c and 44d (FIG. 2) and if so, starts delivery on audiovisual device 71 over line 70. If media desired is found not to be stored locally, media deliverer 69 establishes a connection with media controller 61 and instructs it to update its database. Media controller 61 does so and then checks the database for another copy of the desired media. If media controller 61 locates a copy at another media deliverer, say media deliverer 63, media controller establishes a connection via line 60 to central office 59 and via line 62 with media deliverer 63 and instructs it to send the desired media to media deliverer 69. Media deliverer 65 checks the desired media is local and if so, notifies media controller 61 initiates the transfer to media deliverer 69. Once the transfer is complete, media deliver 69 establishes a connection with media controller 61 and instructs it to update its database. Media deliverer 69 then initiates delivery. In the case that the transfer fails or media is not found, media controller 61 continues to check the other media deliverers in the network until a copy is found.

Similarly, a call originating at telephone 67 is connected via line 66 to central office 59. Equipment at central office 59 checks the called number as above, which in this example is the same toll free “800” number, against a routing database. Despite the fact that this call originates in an area geographically local to media controller 61, central office 59 still connects to long distance network 54, but in this case via line 58 to the point of presence 54c. Equipment at point of presence 54c checks the number and connects back over line 58 to central office 59. Equipment at central office 59 then connects to media controller 61 over line 60. At this point media controller 61 responds to the connection similar to the above. Again, lacking a media deliverer, media controller 61 must locate the media content at a remote media deliverer, and if that media deliverer is not the apparatus associated with the delivery request, instruct that media deliverer to acquire the content from the media deliverer that has it stored locally.

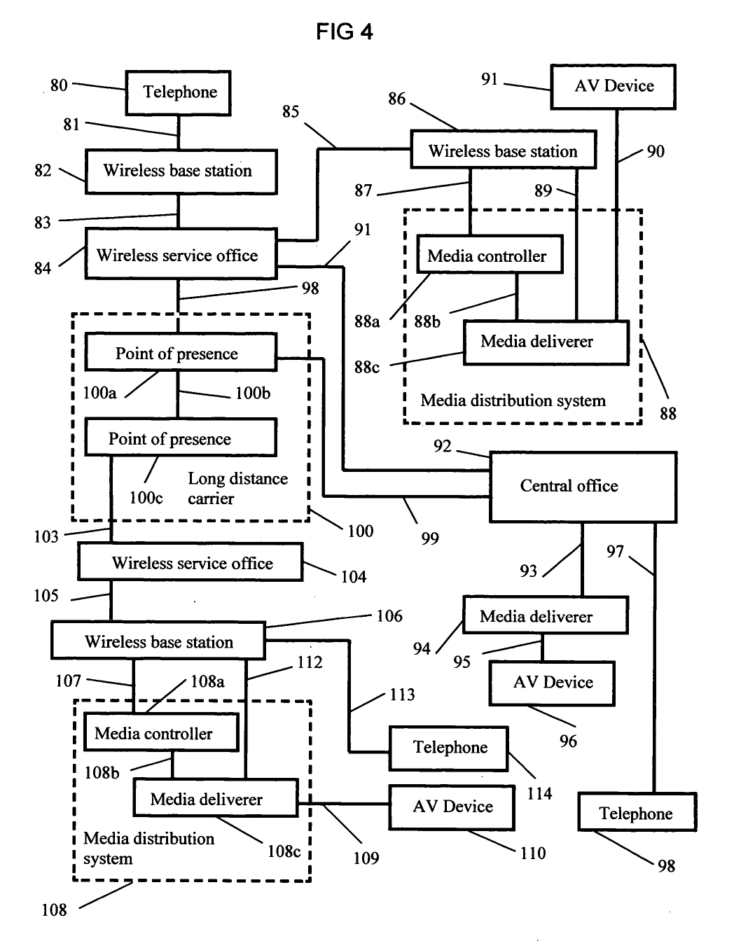

The block diagram in FIG. 4 shows the embodiment of the invention in FIG. 1 with the additional enhancement of the media distribution service connected to the telecommunication network using a wireless transceiver. This enhancement enables the media distribution system to be transported into venues, such as stadiums and arenas, where it will be used for a limited time. This enhancement also allows content providers to provide remote access to their products for promotional purposes as well as revenue generating uses. A caller using wireless telephone equipment 80 calls the wireless telephone number associated with media distribution service 88. The call from equipment 80 connects via 81 to wireless base station 82. Wireless base station 82 connects over line 83 to wireless service office 84. Equipment at wireless service office 84 checks the number and connects over line 85 to wireless base station 86. Wireless base station 86 transmits over 87 to the wireless equipment media controller 88a of media distribution service 88. Media controller 88a directs media deliverer 88c to output the desired content over line 90 to audiovisual device 91, which in this example could be a video screen mounted on the side of a truck that the caller is standing in sight of.

FIG. 4 also shows the additional feature of a wireless call connecting to a wireless media distribution service over a long distance network. A wireless communication initiated using equipment 80 connects over 81 to wireless base station 82. Wireless base station 82 connects via line 83 to wireless service office 84. Equipment at wireless service office 84 checks the called number against a routing database and connects via line 98 to point of presence 100a of long distance network 100. Equipment at point of presence 100a checks the called number and connects over line 100b to point of presence 100c. Equipment at point of presence 101c checks the number and connects over line 103 to wireless service office 104. Equipment at wireless service office 104 checks the number and connects over 105 to wireless base station 106. Wireless base station 106 transmits over 107 to wireless equipment of media controller 108a of media distribution service 108. Media controller 108a communicates via 108b with media deliverer 108c to output the desired content over line 109 to audiovisual device 110. This audiovisual device could be a remote broadcast unit at a live telecast, for example.

In the above examples, if any of the wireless media distribution service equipment moves from range of one base station to another, for example, from wireless base station 86 to wireless base station 82 or 106, the routing of the connection changes without affecting the utility of the media controller or the media deliverer.

Also note that wireless base stations 86 and 106 are easily accessed by a caller at wire line telephone equipment 98, by routing through central office 92 and then via long distance network 100 to respective wireless service offices 84 and 104. Content selected by the caller at telephone 98 could be delivered using AV device 96 attached to media deliverer 94, which would acquires the content, if needed, from media deliverer 88c or 108c.

The additional enhancement illustrated in FIG. 4 is accomplished by augmenting the telecommunication network interface in FIG. 2 by adding a wireless transceiver. The equipment would be functionally identical to that shown in FIG. 2, but would now connect to a wireless base station rather than a wire line network.

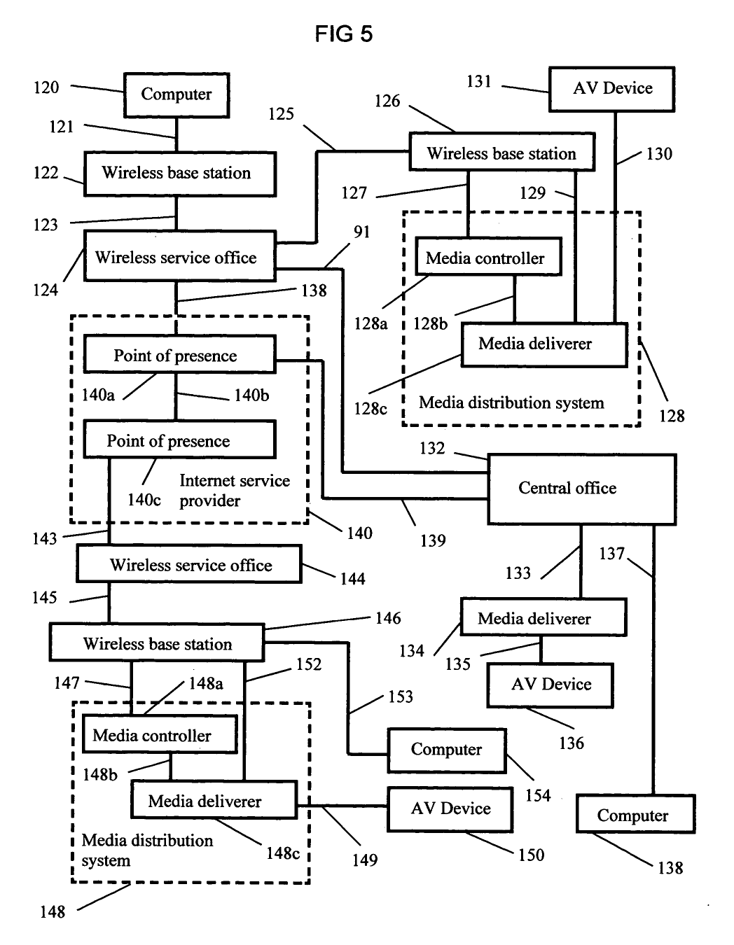

The block diagram in FIG. 5 shows the embodiment of the invention in FIG. 1 with the additional enhancement of the media distribution service connected to the network with a wireless data connection. A data call originating at wireless modem equipment of computer 120 is transmitted over the air connecting via 121 to wireless base station 122. Wireless base station 122 is connected via line 123 to wireless service office 124. Equipment at wireless service office 124 connects via line 138 to point of presence 140a of Internet service provider 140. Internet service provider point of presence 140a connects to point of presence 140c over circuit 140b. For simplicity, other Internet service providers and indeed most of the Internet backbone are not represented here. Moreover points of presence 140a and 140c may be operated by separate organizations exchanging traffic (transparently to the user) because of peering arrangements, which are common on the Internet. They are shown as one Internet service provider for clarity, here. Internet service provider point of presence 140c connects over line 143 to wireless service office 144. Equipment at wireless service office 144 connects over line 145 to wireless base station 146, which transmits via 147 to media controller 148a of wireless (in this case) media distribution service 148.

The enhancement shown in FIG. 5 is accomplished by a small client program running on the user's computer or personal digital assistant, both of which are equipped with connectivity equipment. The user accesses the media distribution service by connection to their wireless or wire line Internet service provider, via dial up, DSL, Ethernet, etc., technology. Once connected, the user enters the media distribution service's identifying number, which is generally the telephone number displayed using the system output. The client program then connects to a database using the connection provided by the Internet service provider to access the media distribution service. The media distribution service returns the appropriate selection prompts for output on the computer or personal digital assistant display. Of course, the prompts are also displayed, where appropriate, on the media distribution system output and can optionally be output in audio form on the computer or personal digital assistant.

FIG. 5 also demonstrates how a computers and personal digital assistants with wireless and wire line connections are able to access the various media service configurations demonstrated in FIGS. 1, 3 and 4. As in the previous examples, computer 154 connected using wireless technology and computer 138 connected using wire line technology can access any media controller and media deliverer in the network. Media deliverers 128c and 148c have access to all media content as in the previous examples regardless of type of connection.

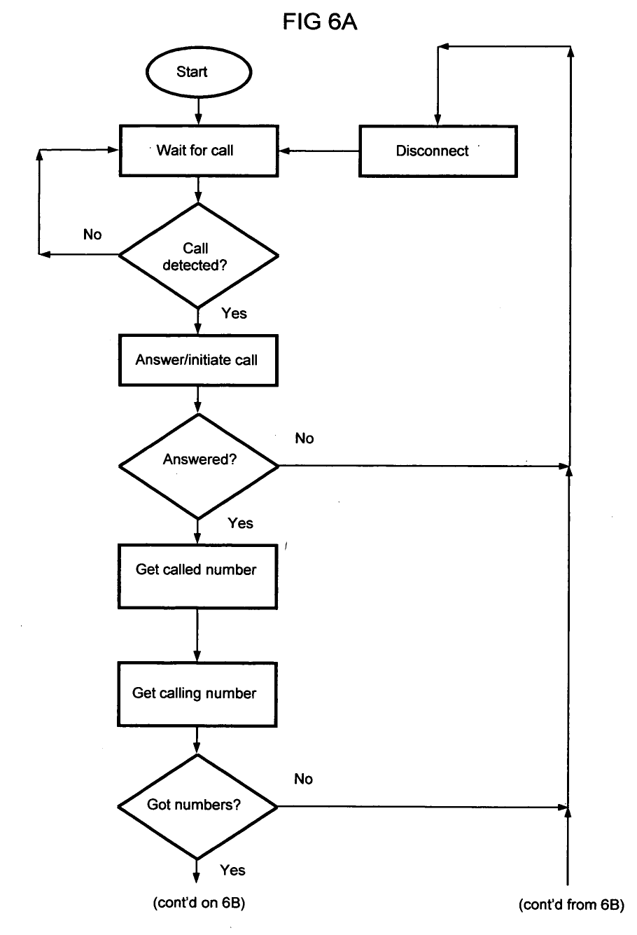

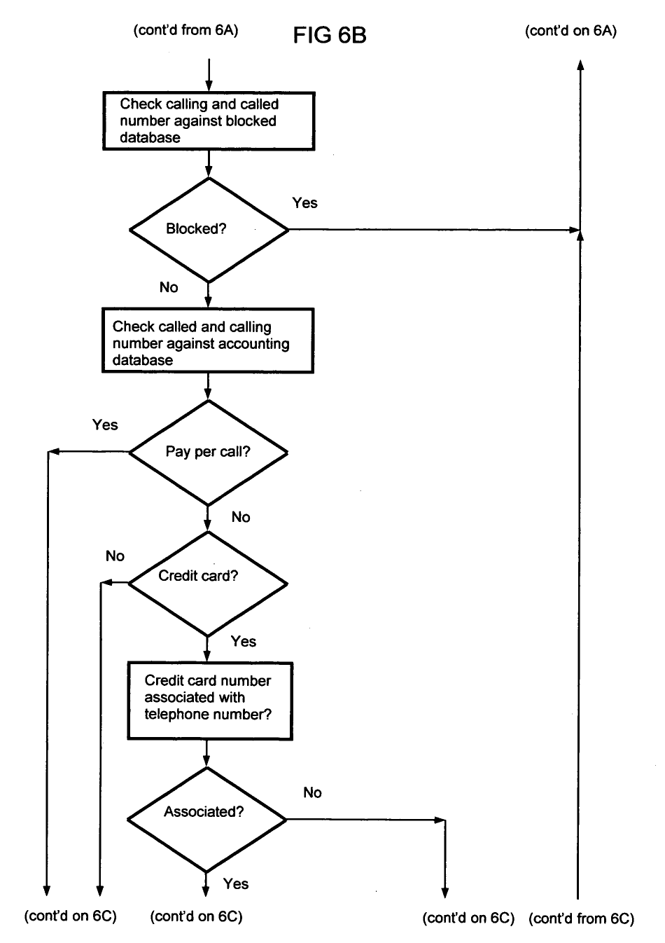

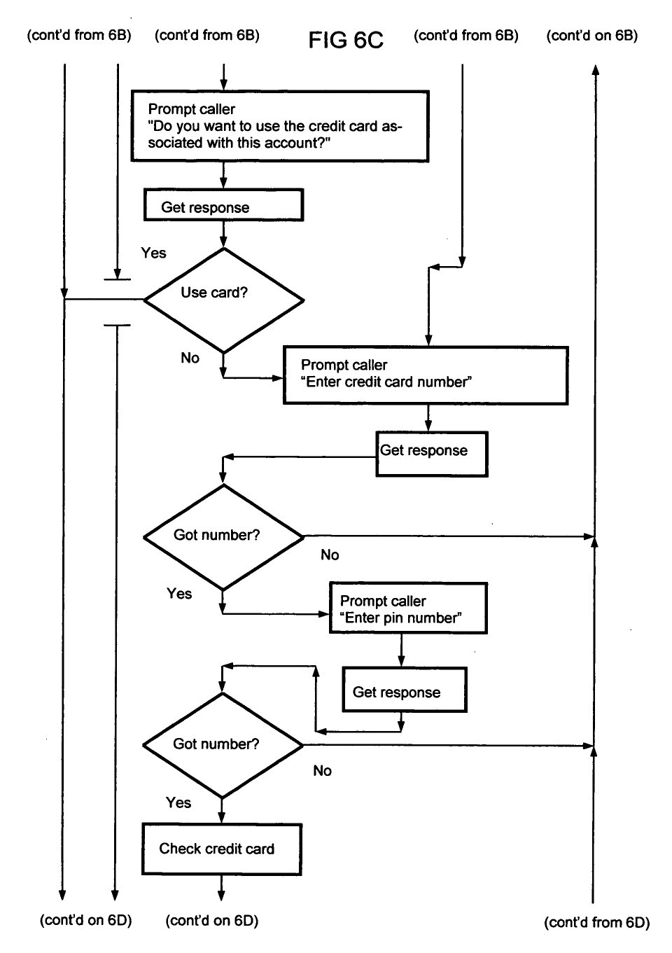

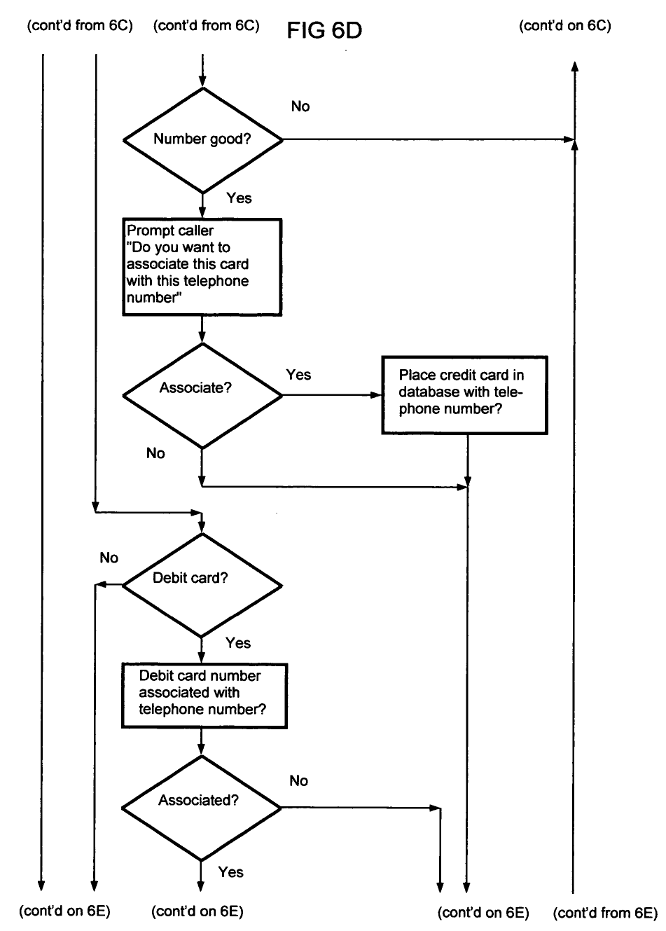

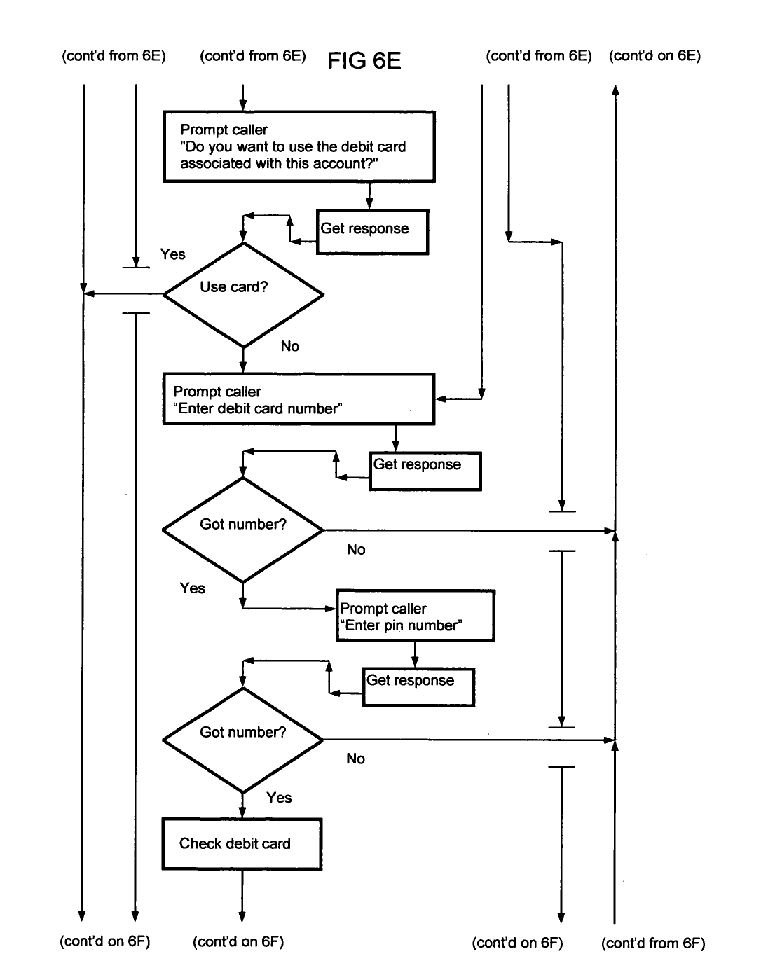

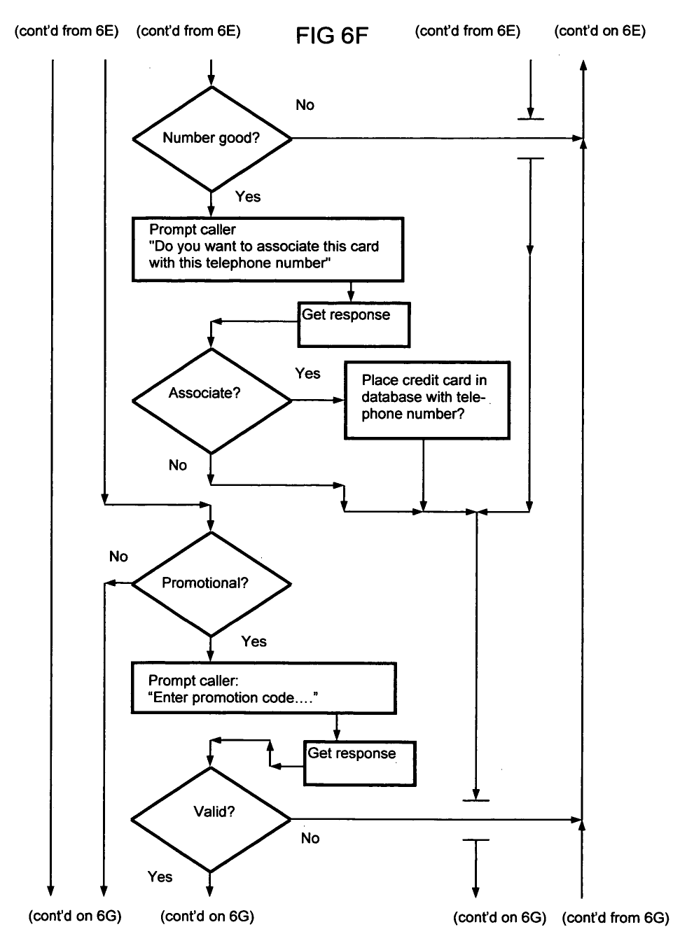

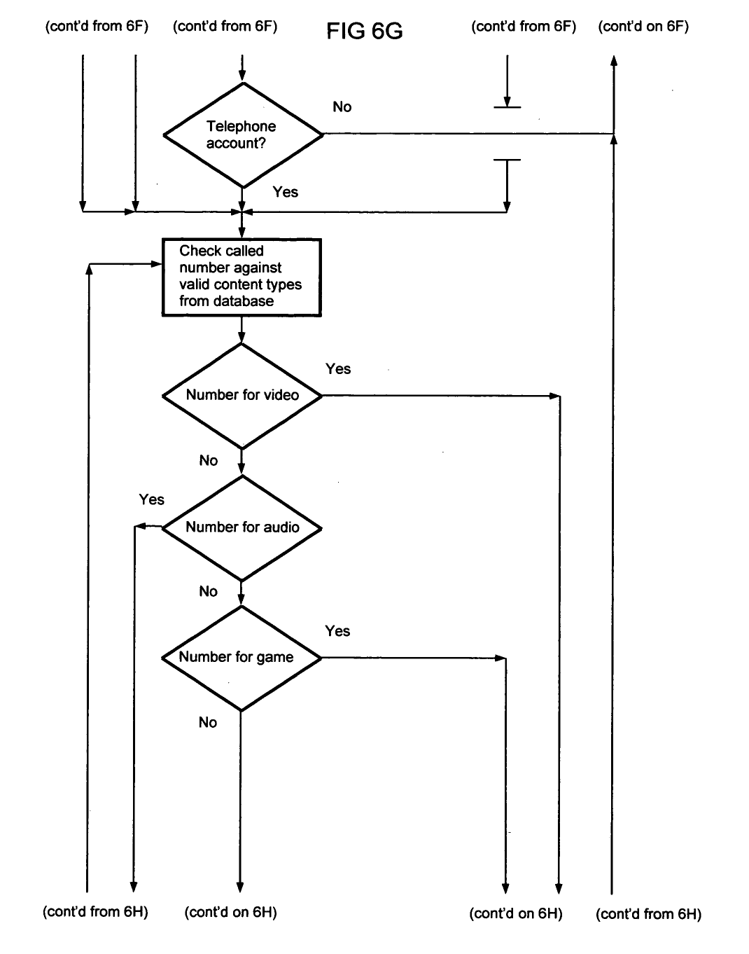

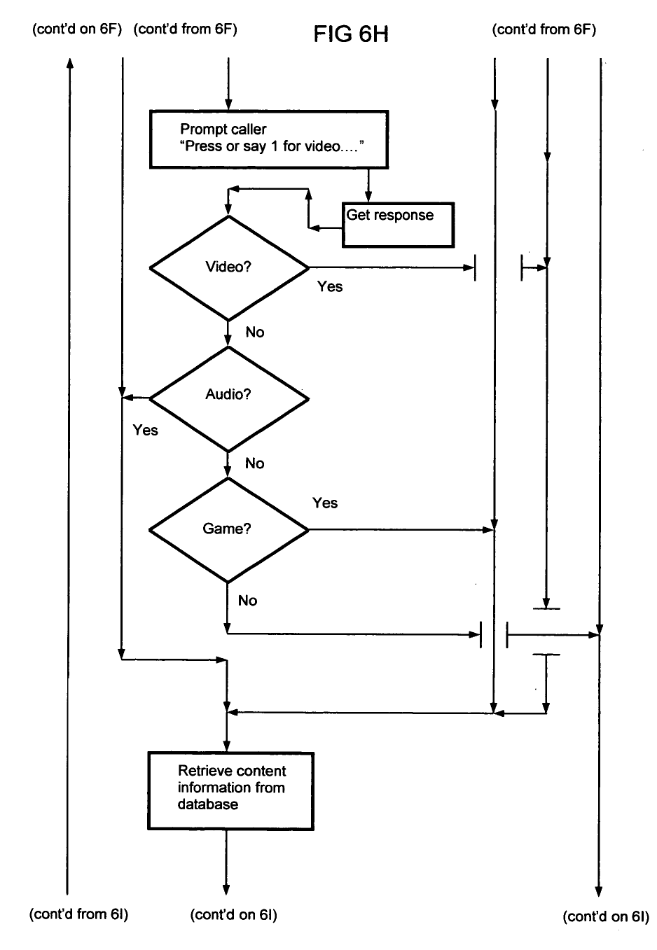

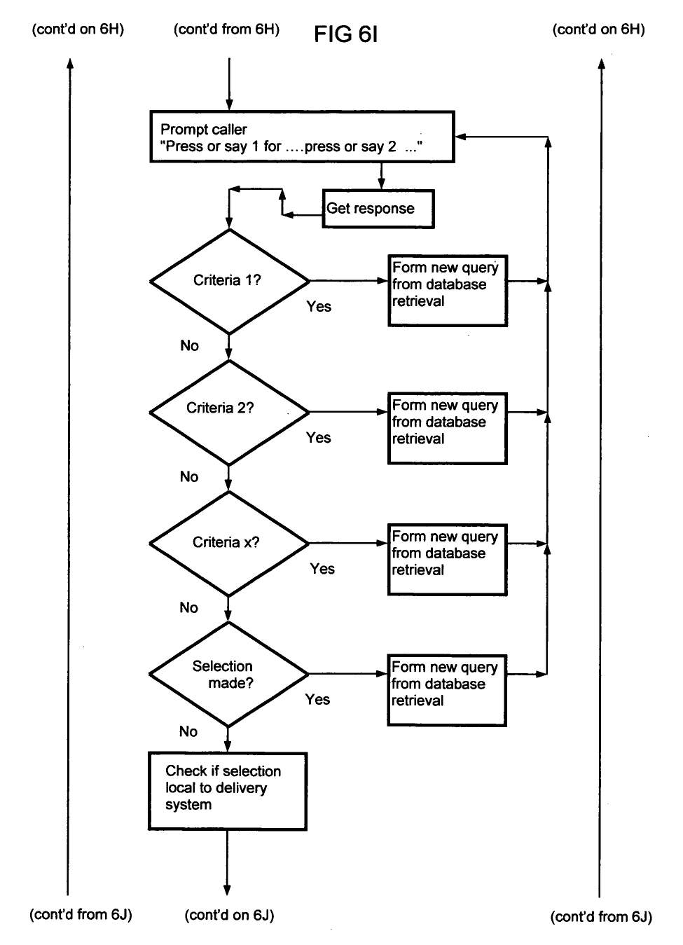

The block diagram consisting of FIGS. 6A, 6B, 6C, 6D, 6E, 6F, 6G, 6H, 61 and 6J illustrates the flow of the media distribution service software. In this description, whenever reference is made to data, the data are contained in the appropriate storage of the apparatus and the software of the computer provides access to these data and use of the data as described below. Moreover, the computer has the capability to process multiple calls concurrently in the manner described. The computer also has the capability of running multiple software programs, both similar and different, concurrently. In the initial state, the media distribution service waits for incoming calls. It is also waiting here for the command to make an outgoing call, which is essentially the reverse process and since it will be implemented as a subset of the features, minor differences are omitted here. When a call is detected, the media controller service “answers” the call and gets the number of the called party and the number of the calling party from the line. Alternately, if the system has initiated the call, the media controller goes “off hook,” makes the call, and waits for the party to answer. As described earlier, the number of the calling party and the number of the called party are obtained, alternatively, in other ways, for example, a separate signaling circuit, but these other methods are omitted in this description for simplicity. Moreover, the entire selection process is not described here, as the number of choices is virtually limitless.

The media distribution service then checks both telephone numbers against the database for actions associated with them. If the calling number is blocked for any reason, the media distribution service disconnects the call and waits for a new one. The called number is checked to see what billing mechanism is associated with it, for example, pay-per-call, credit card, debit card, and the calling number is checked to see if there is an appropriate account number associated with the telephone number. The caller is prompted as to payment options if appropriate, including using a credit or debit card associated with the calling telephone number or associating a new credit or debit card with the calling telephone number.

If the media distribution service determines that the call can continue based on the called number, the calling number and any user responses, the caller is prompted over the line and optionally by the system video and or audio outputs to make a media selection. The media distribution service uses the caller responses in conjunction with the information stored in the content database in order to narrow down the available options and make a selection with a reasonable number of choices.

First, the media distribution service checks the called telephone number to see if there is a particular media type, for example, music, video or video game, associated with it. If there is, the media distribution service accesses the database in order to prompt the caller. For example, if the number was associated with a audio selection, the prompt retrieved from the database might be “Press or say ‘1’ for rock, press or say ‘2’ for pop . . . ” If the number is not associated with a media type, the prompt may first be, “Press or say ‘1’ for video, press or say ‘2’ for audio, press or say ‘3’ . . . ” After the system receives and processes the response to this prompt, it accesses the database to retrieve another prompt, such as “Press or say ‘1’ for rock, press or . . . ”.

The media distribution service then presents the caller with prompts that lessen the number of possible selections so that the caller can choose one media item for delivery. If, for example, the caller had selected either “rock” or “pop” above, the service could prompt “Press or say ‘1’ to search by artist, press or say ‘2’ to search by title” and the criteria (see FIG. 6I) selected by the caller would be used to access the database and form the next prompt. If, for example, the called chose to search by artist, the next prompt could be “Press or say ‘1’ for artist names from ‘A’ to ‘E’, press or say ‘2’ for artist names from ‘F’ to ‘J’ . . . ” or even “Enter the first few letters of the artist's last name . . . ” or “Say the artist's name . . . ” This series of prompts and responses continues until the caller has made their selection (or perhaps just terminated the operation by command or hang up).

Selection is not complete until all available options have been chosen or default settings are used. This is not usually an issue with downloaded music or video (although, pressing a confirmation key, “Press or say ‘1’ to confirm your selection” or even “Press or say ‘1’ to accept the terms of this license,” will be used in many situations), but interactive media may have several options. Interactive video games will have several options, such as number of players and skill levels, and transactional media will have quantity, shipping, insurance, etc.

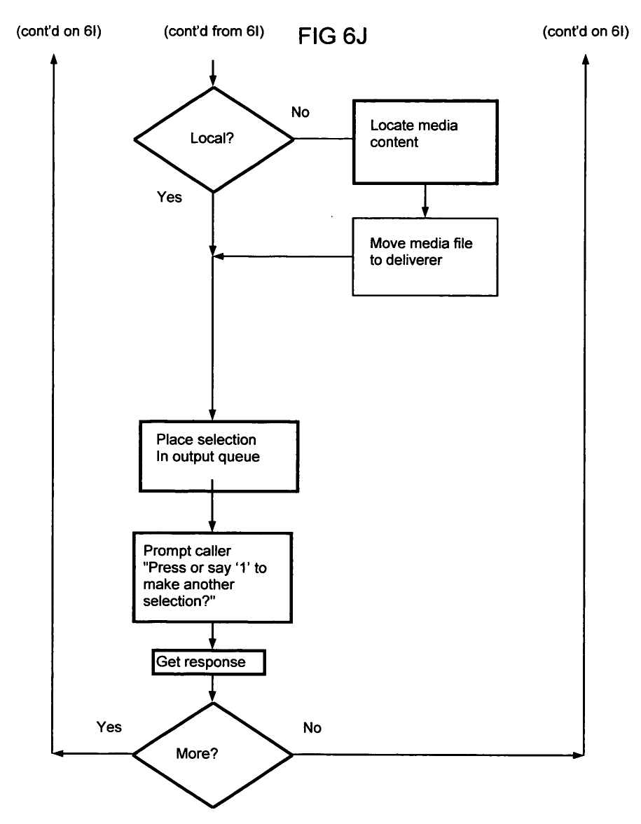

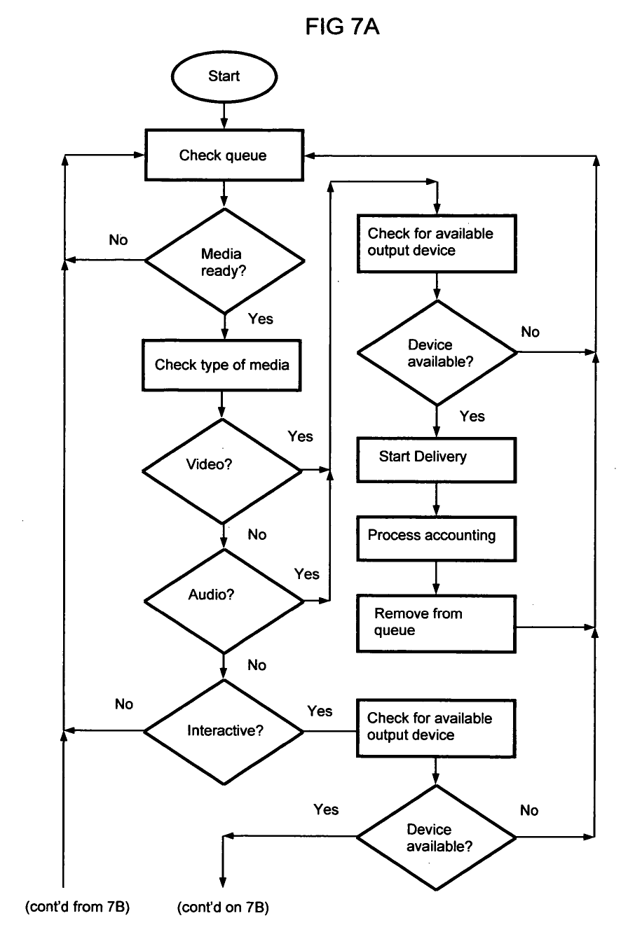

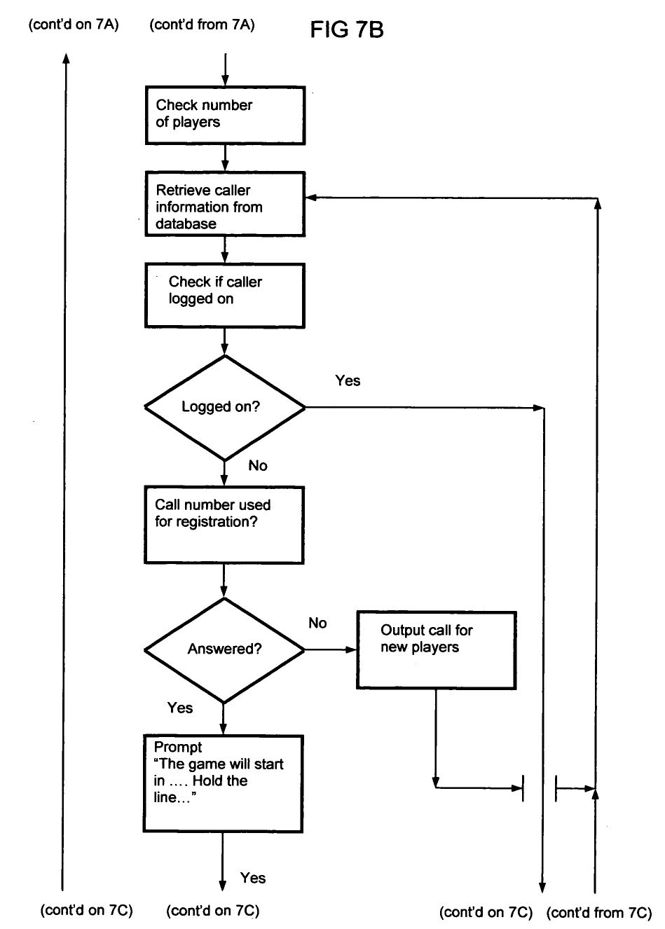

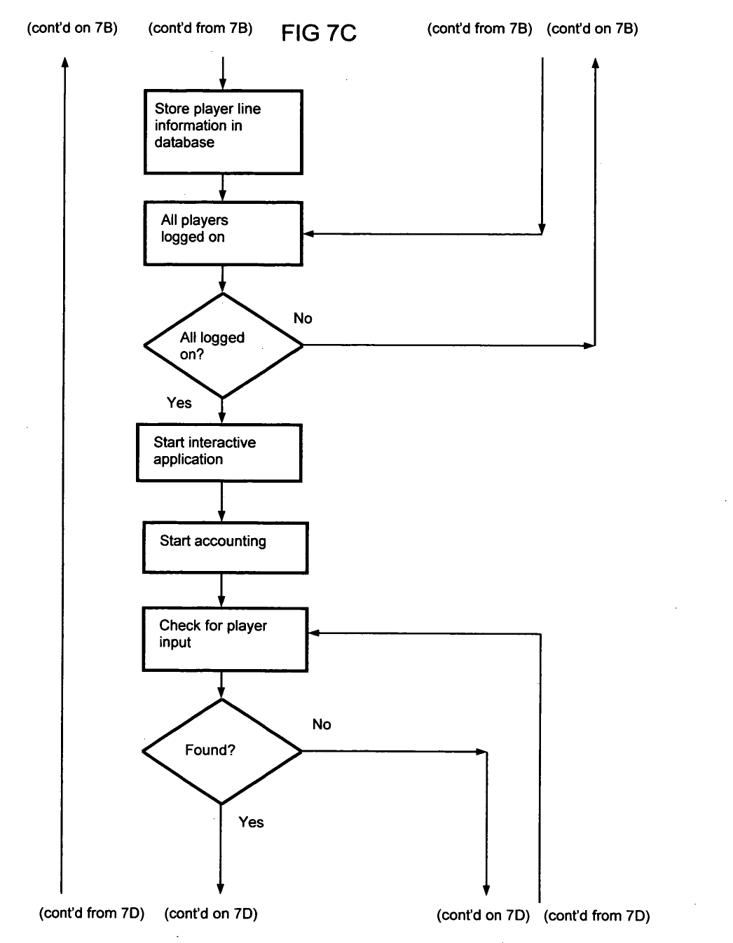

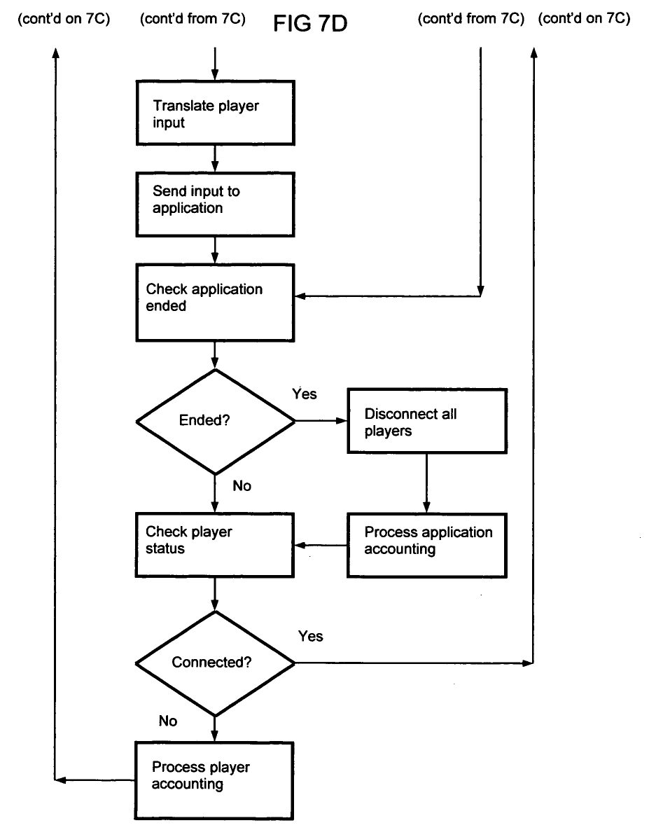

Once the selection has been made, the choice is placed in an output queue for subsequent delivery (see FIG. 7) and the caller is prompted as to whether or not they would like to make an additional selection and if the caller responds in the affirmative, continues.

The block diagram consisting of FIGS. 7A, 7B, 7C and 7D illustrates the flow of the media distribution service software that handles the actual delivery. This software runs in parallel with the software used to select media for distribution. In this description, as above, whenever reference is made to data, the data are contained in the appropriate storage of the apparatus and the software of the computer provides access to these data and use of the data as described. The computer also has the capability of running multiple software programs, as above, concurrently. In this program, the media distribution service continually checks for media content awaiting delivery. When delivery is required, the media distribution service determines the resources needed, accesses them and commences delivery.

The media delivery software, in its initial state, checks the delivery queue for media that has been selected but not yet delivered. If media is found, media delivery service checks to see if there is already media being output on media system output. If the media in the delivery queue is not interactive, for example, audio or video jukebox output, and there are available output devices, the system can just deliver it and process the accounting data. If the media to be delivered is interactive, the media delivery system checks options, for example, to see how many players are needed, and of these how many players are registered and logged on. If, in this case, there are not enough registered players, the system will output on an available display device a call for more players, “We need . . . more players for . . . Call . . . to join the game.” Once there are enough players, the system accesses the database to see if they are currently logged on to the system. If they are not, the system calls the mobile telephone number they used when they registered. If the player answers, the system prompts, “We will be starting the game . . . in . . . [minutes/seconds]. Hold the line to play.” If enough of the registered players do not respond in some finite time interval, the media deliverer will case the system output to display a call for additional players.

Once all the players are logged onto the system (and new players registered if necessary), the media system starts the interactive application, which starts the actual delivery over the system display device. The system must then start accounting for the media delivery especially in the case where a media content provider will be compensated for the use of the media and where the users will be charged for the delivery of the media content.

Once the interactive application is started, the system must monitor the telephone lines for user input. When a user pushes a wireless telephone key, the system must capture that keystroke, determine which user pressed the key and translate that information into information, for example, from a touch tone to a mouse click, that can be passed onto the interactive application so that the video and audio output of the delivery mechanism properly reflect that input.

The system must at all times monitor for the end of the interactive application and individual player log outs so that accounting information accurately reflects usage. Once the application has completed, the system must update the accounting information.

The system must also disconnect all players, process accounting information and check for the next event in the queue.

Media Distribution Service Configuration

The computer that comprises the core of the media delivery service system in exemplary apparatus is a microcomputer with an Intel Pentium microprocessor running the Microsoft Windows 2000 operating system with added telephony and voice processing enhancements in the form of hardware and software. Referring to FIG. 2, the hardware enhancements include one expansion board that contains a voice and tone processor 43, featuring digital signal processing hardware and firmware, and analog to digital converters, and a telecommunications network interface 41. The software enhancements include the software drivers required for the expansion boards, plus a proprietary application program written in Microsoft C/C++. Dialogic Corporation, a subsidiary of Intel, manufactures the expansion board and software drivers. The computer requires one PCI expansion slot to accommodate the Dialogic expansion board. It may require another PCI or AGP slot for an optional video card if the computer is being used to output display graphics also. The computer may also need an expansion slot for audio output. Most computers running Windows 2000 (or subsequent Microsoft operating systems) can be used in this system. Other Windows operating systems, such as NT or Windows XP may require additional software and hardware drivers for some of the functionality.

Voice and tone processor 43 and related software are used to select the media desired by responding to call, prompting the connected callers, capturing and translating their responses, to capture and generate tones for dialing, and to monitor events on the lines and determine the status of the calls.

Telecommunication network interface 41 is used to link the computer with the public switched telephone networks as well as private networks. The network interface in any particular configuration is either digital or analog. Analog and digital network interfaces may be combined in a single computer.

Central processing unit 45 controls the call switching and routing as well as media control and accounting.

The computer also requires a mass storage system 44, which is used to store the system control software 44a, media system database 44b, media content program files 44c, media content data files 44d, and accounting database 44e as well as other programs and data needed to implement the function of the advertising service.

The media control apparatus and the media delivery apparatus, while functionally distinct, both use the computer and telephone equipment contained in the media distribution service. The media control apparatus and the media delivery apparatus are distinguished by the computer software that controls the equipment with which they are implemented.

Media System Database Structure

Media content data are stored in digital form on the computer along with a database that contains the selection criteria relevant to each individual. This database controls the (1) selection criteria prompts to callers so that media can be chosen quickly and efficiently (2) media delivery information used for accounting. Each individual media content item has (1) a unique identifier, (2) a type, that is “Audio,” “Video,” “Game,” etc., (3) a genre, for example “Audio” would contain “Classical,” “Rock,” “Rap,” etc., “Game” would include “Action,” “Sports,” etc, (4) a format, for example, “Video” would include “Feature,” “Episode,” “Music Video,” etc., “Audio” would include “Album,” “Single,” etc., (5) publisher, (6) year, etc. Each individual media content item has storage for (7) number of simultaneous user, (8) transactional information, (9) actual storage location, etc. Each individual media content item will be linked to a “talent” database where musicians, actors, actresses, directors, and characters associated with each media content item are stored so that users can search on names.

The media system database also contains information related to the licensing and ownership of the media content, such as (a) dates that the media is allowed (or not allowed) to be delivered in, (b) how many times it has been delivered, (c) at what time(s) it is allowed (or not allowed) to be delivered, (d) in what geographic area(s) it is allowed (or not allowed) to be delivered in, (e) if it must be run exclusive of other media content either per access or per user account, and (f) with what other media it must be delivered, and (g) in what sequence, if any, it must be delivered. To accomplish this, the database contains the following information for each ad message: (a) Unique media content ID number; (b) area codes that the media may or may not be delivered to; (c) telephone exchanges within area codes that the media may or may not be delivered to; (d) the times of day during which media may or may not be delivered; (e) the days of the week on which media may or may not be delivered; (f) the ordinal position that the media may or may not appear in; (g) the unique media id numbers preceding and following the particular item in a series; (h) whether the media must be exclusive of other media content; (i) length of the media content.

Accounting Database

The illustrated media distribution service apparatus stores information pertaining to the delivery of each media content item for accounting purposes. This information includes (a) media identifier; (b) the calling number; (c) the called number; (b) the date media was delivered; (e) the media was delivered. The total extent of delivery of each media item over a period—days, weeks or longer—can be derived from such data storage.

The accounting database also includes user information, such a (a) name, (b) address, (c) credit card or debit card number or both, (d) telephone number, (e) password, (f) pin number, etc., to facilitate billing.

Alternative Embodiments of the System

The described media distribution service apparatus could operate in much the same fashion as described here if it consisted of components that are functionally similar to those described.

The computer that comprises the system is an Intel based microcomputer equipped with voice processing and telephone interface hardware and software, and proprietary software. Any other computer, including a workstation, minicomputer, mainframe, supercomputer or dedicated computer, equipped with voice and tone processing hardware and software could replace the microcomputer described herein. There are several other manufacturers of voice and tone processing, telephone network interface, and telephone switching expansion boards, such as Natural Microsystems and Rhetorex, as well as several manufacturers of functionally similar telephone system equipment, such as Rockwell and Fujitsu. Much of this hardware and software is readily available and that which must be constructed can be constructed out of readily available components and systems.

Furthermore, much of the computer processing and storage can be moved from the front end computer to a local area network (LAN) server or wide area network (WAN) server to centralize media content management, billing and accounting. The functions can be moved as modules, keeping as much processing as necessary in the front-end computer. The computer processing and storage could be further moved to a mainframe or minicomputer.

The illustrated apparatus, using digital media storage and retrieval, could also be implemented using an analog system for media content storage and retrieval with minor modification. The structure of the software would be basically the same.

The described media distribution service apparatus, intended to be used with the public switched telephone network, including both local exchanges and long distance interexchange carriers, could also be used in any public or private telecommunication network.

As used in the description above of the novel media distribution service apparatus, the term “media content” is not limited to music, videos and games as described for the most part herein, but includes any kind of message, such as shopping, educational instruction, religious programming, that can be stored and forwarded.

1. A communication network having numerous telecommunications equipment and one or more audiovisual display devices and a method of connecting any of said equipment and one or more of said devices, the improvement wherein at least one media distribution apparatus is provided, a respective one of said media distribution apparatuses being connected to any of said equipment using said method, and a respective same or another of said media distribution apparatus being connected to any of said devices using said method, one or more of said media distribution apparatuses having media control means and one or more of said media distribution apparatus having media delivery means, said control means including means for selecting and manipulating media content items and said delivery means including storage means.

2. The communication network of claim 1 wherein said media control means includes means for providing outputs to said telecommunications equipment and said display devices.

3. The communication network of claim 2 wherein said outputs are provided as audio, video or data messages.

4. The communication network of claim 1 wherein said media control means includes means for accepting inputs from said telecommunications equipment.

5. The communication network of claim 4 wherein said inputs are accepted as audio or data messages.

6. The communication network of claim 1 wherein said media control means can be accessed by one or more of said telecommunications equipment simultaneously.

7. The communication network of claim 1 wherein said storage means include storage system control software, media system database, media content programs, media content data, and system accounting database.

8. A media distribution apparatus, connected to numerous telecommunications equipment and one or more audiovisual display devices, having media control means and media delivery means, said control means including means for selecting and manipulating media content items and said delivery means including storage means.

9. The apparatus of claim 8 wherein said media control means includes means for providing outputs to said telecommunications equipment and said display devices.

10. The apparatus of claim 9 wherein said outputs are provided as audio, video or data messages.

11. The apparatus of claim 8 wherein media control means includes means for accepting inputs from said telecommunications equipment.

12. The apparatus of claim 11 wherein said inputs are accepted as audio or data messages.

13. The apparatus of claim 8 wherein said media control means can be accessed by more than one of said telecommunications equipment simultaneously.

14. The apparatus of claim 8 wherein said storage means include storage system control software, media system database, media content programs, media content data, and system accounting database.

15. A method for selecting, manipulating and displaying media content comprising a communications network, which connects telecommunications equipment to media selection apparatus including media control means for processing commands and accessing data in order to access, select and manipulate media content items in media storage means, and including media delivery means to output media content items to one or more audiovisual display devices.

16. The method of claim 15 wherein said media control means includes means for providing outputs to said telecommunications equipment and said display devices.

17. The method of claim 16 wherein said outputs are provided as audio, video or data messages.

18. The method of claim 15 wherein said media control means includes means for accepting inputs from said telecommunications equipment.

19. The method of claim 18 wherein said inputs are accepted as audio or data messages.

20. The method of claim 15 wherein said storage means include storage system control software, media system database, media content programs, media content data, and system accounting database.
